(19) United States
(12) Patent Application Publication
(10) Pub. No.: US 2006/0118291 A1
(43) Pub. Date: Jun. 8, 2006

(54) Air conditioner for vehicle capable of immediately cooling vehicle compartment

(75) Inventor: Toshihiko Muraki, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/291,269

(22) Filed: Dec. 1, 2005

(30) Foreign Application Priority Data
Dec. 2, 2004 (JP) 2004-350353

(51) Int. Cl. B60H 3/00; B60H 1/00; B61D 27/00

(52) U.S. Cl. 165/202; 165/42

(57) ABSTRACT

A short circuit duct 18, which branches at least part of air flowing through a cold air bypass passage 16 and causes a fan to suck it, is provided. According to this, part of cold air is taken out at a position as close as possible after an evaporator and is circulated again through a route as short as possible, whereby the discharged air temperature is further reduced. A low discharged air temperature can be attained quickly by efficiently returning the cold air immediately after the evaporator to the fan through the shortest route, which can be realized by providing an air introduction inlet 19 directly to an air conditioning case on the top surface of the existing cold air bypass passage 16 immediately after the evaporator 9 and using the short circuit duct 18 with small heat capacity after the air introduction inlet.

### BACKGROUND OF THE INVENTION

1. Field of the Invention

The present invention relates to an air conditioner, for a vehicle, mounted on a vehicle such as an automobile to perform cooling, heating, etc. More particularly, it relates to an air conditioner for a vehicle comprising a cold air bypass passage for directly guiding air having passed through an evaporator to a face opening while causing the air to bypass a heater core and an air mix section.

2. Description of the Related Art

Recently, there is an increasing demand to obtain cold air as soon as possible at the time of cool-down of a vehicle compartment immediately after boarding. However, conventionally, it usually takes a few minutes to obtain air cold enough to cause a passenger to feel comfortable. Besides the problem of the cooling capacity of the air conditioner, the biggest problems are that (1) the temperature of the sucked air is high and that (2) the heat losses in air distribution ducts after an evaporator are large.

As a technique to solve the above-mentioned problems, the inventors of the present invention have devised the technique shown in the patent document 1. The object of the technique is to reduce or increase the discharged air temperature by providing an air leakage port and an open/close door at-an air distribution duct for side face and by causing a blower to suck some air from the air leakage port.

[Patent document 1] Japanese Unexamined Patent Publication (Kokai) No. 2003-104033

However, the technique in the above-mentioned patent document 1 is insufficient as a countermeasure against the problem that (1) the temperature of sucked air is high because air discharged from the air leakage port diffuses from a part deep in an instrument panel so that the structure is not necessarily one in which all the air is sucked by the blower from the air leakage port.

Further, as a countermeasure against the problem that (2) the heat losses in the air distribution ducts after the evaporator are large, it is insufficient because air discharged from the evaporator flows through an air conditioning unit and an already existing vehicle air distribution duct, thereby receiving heat and, therefore, the temperature of the air rises before it is sucked by the blower.

Furthermore, there is another problem that the cost is increased because of the need to provide a space for an open/close door to be provided in the air distribution duct, and due to the cost of the door and a drive mechanism.

### SUMMARY OF THE INVENTION

The above-mentioned conventional problems being taken into account, the present invention has been developed, although cooling is focused on, and the object thereof is to provide an air conditioner for a vehicle capable of improving the capability for immediately cooling passangers at a low cost.

In order to attain the above-mentioned object, the technical means described in first to fifth aspects are employed. In other words, an air conditioner for a vehicle according to a first aspect of the present invention comprises an air conditioning case (3) forming an air passage, an air supply means (8) arranged at one end of the air conditioning case (3) and taking in air for air-conditioning to supply the air into the air conditioning case (3), a cooling means (9) for cooling the air supplied from the air supply means (8), a heating means (10) for heating the air having passed through the cooling means (9), a bypass passage (11) through which the air having passed through the cooling means (9) flows while bypassing the heating means (10), an air flow rate ratio adjusting means (12) arranged on the upstream side of the heating means (10) and the bypass passage (11) and adjusting the air flow rate ratio between flow rate of the air passing through the heating means (10) and flow rate of the air passing through the bypass passage (11), an air mix section (13) for mixing the hot air heated by the heating means (10) and the cold air supplied from the bypass passage (11), a face opening (14) arranged at the other end of the air conditioning case (3) and supplying the air from the air mix section (13) toward the upper body of a passenger in a vehicle compartment, and a cold air bypass passage (16) for guiding the air having passed through the cooling means (9) in the air conditioning case (3) to the face opening (14) while causing the air to bypass the heating means (10) and the air mix section (13), wherein a short circuit duct (18) for branching at least part of the air flowing through the cold air bypass passage (16) and causing the air supply means (8) to suck it is provided, an air introduction inlet (19) for introducing air from the cold air bypass passage (16) is provided on the outer surface of the air conditioning case (3), and the short circuit duct (18) is constituted of the outer surface of the air conditioning case (3) and a cover part (18a) for covering the air introduction inlet (19) from the further outer surface side with a space interposed between the cover part and the air introduction inlet and installed with a space interposed between the cover part and the outer surface of the air conditioning case (3).

This is because of a devised structure, in which part of cold air is taken out at a position as close as possible after the cooling means (9) and circulated again through a route as short as possible, whereby the discharged air temperature is further reduced. According to the invention described in the first aspect, as for the above-mentioned problems that (1) the temperature of sucked air is high and that (2) the heat loss in the air distribution duct after the evaporator is large, it is possible to obtain the maximum effect that a sufficiently low discharged air temperature can be attained quickly by efficiently returning the cold air immediately after having passed through the cooling means (9) to the air supply means (8) through the shortest route, which can be realized by providing the air introduction inlet (19) directly to the air conditioning case (3) on the top surface of the already existing cold air bypass passage (16) immediately after the cooling means (9) and using the dedicated short circuit duct (18) with small heat capacity from the air introduction inlet (19).

In an air conditioner for a vehicle in a second aspect of the present invention according to the above-mentioned first aspect, the cold air bypass passage (16) has a cold air bypass door means (16a) for causing air to flow intermittently through the cold air bypass passage, and the air introduction inlet (19) leading to the short circuit duct (18) is opened and closed by the cold air bypass door means (16a).

In an air conditioner for a vehicle in a third aspect of the present invention according to the above-mentioned second aspect, the air introduction inlet (19) is opened to circulate air using the short-circuit duct (18) at least at the initial stage of cool-down when cooling starts.

In an air conditioner for a vehicle in a fourth aspect of the present invention according to the above-mentioned first to third aspects, the air supply means is configured so as to take in air from a suction port provided on the upper side of the air supply means and supply air into the air conditioning case, the cold air bypass passage is provided on the upper side of the heating means, the air introduction inlet is provided on a top surface of the air conditioning case, the cover part is installed from the upper outer surface side of the air conditioning case, and an air discharge port for causing the air having passed through the short circuit duct to flow out to the air supply means is provided on the upper side of the air supply means and on the lower side of the suction port.

In an air conditioner for a vehicle in a fifth aspect of the present invention according to the above-mentioned fourth aspect, between the air supply means and the suction port, a filter for removing dust in sucked air is provided and the air discharge port is provided on the upper side of the air supply means and on the lower side of the filter.

The present invention may be more fully understood from the description of the preferred embodiments of the invention set forth below, together with the accompanying drawings.

### BRIEF DESCRIPTION OF THE DRAWINGS

In the drawings:

FIG. 1 is a top view of an air conditioner for a vehicle in an embodiment of the present invention.

FIG. 2 is a diagram showing A-A section view of an air supply unit 1 and B-B section view of an air conditioning unit 2 in FIG. 1 side by side, also showing a state in which an air introduction inlet 19 to a short circuit duct 18 is opened by a cold air bypass door 16a.

FIG. 3 is a diagram showing a state in which the air introduction inlet 19 to the short circuit duct 18 is closed by the cold air bypass door 16a, in B-B section view of the air conditioning unit 2 in FIG. 1.

### DESCRIPTION OF THE PREFERRED EMBODIMENTS

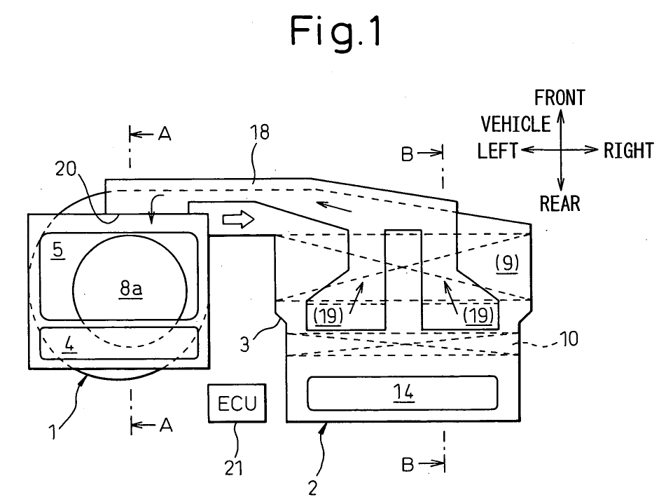

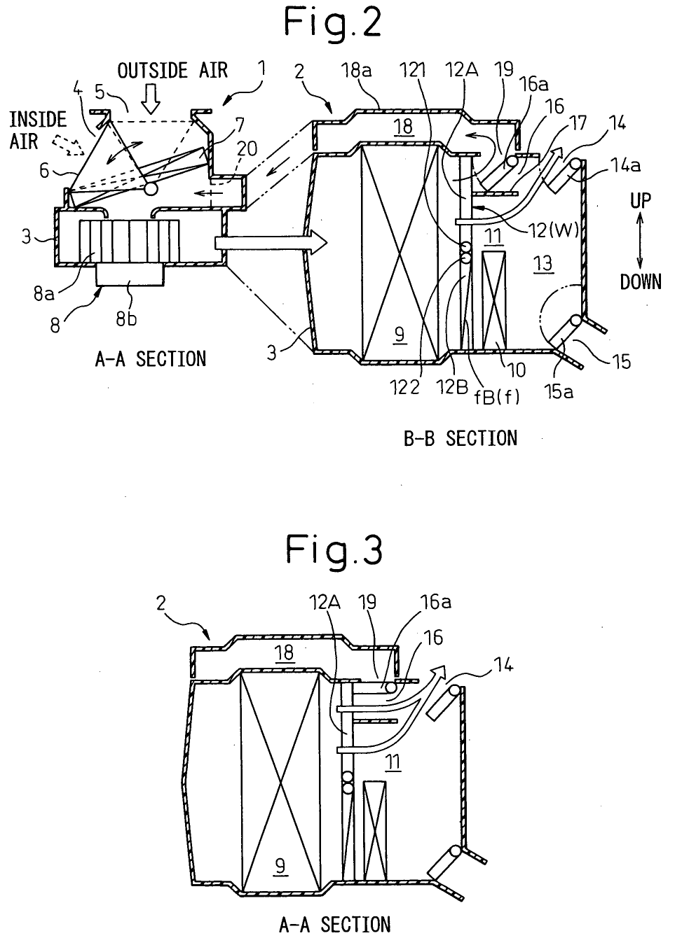

Embodiments of the present invention are explained below in detail using drawings. FIG. 1 is a top view of an air conditioner for a vehicle in an embodiment of the present invention. FIG. 2 is a diagram showing A-A section view of an air supply unit 1 and B-B section view of an air conditioning unit 2 in FIG. 1 side by side, also showing a state in which an air introduction inlet 19 leading to a short circuit duct 18 is opened by a cold air bypass door 16a. In the explained embodiment, the present invention is applied to an air conditioner for a vehicle that is installed at the front seat of a vehicle in which a water-cooled engine is installed.

The ventilation system of the air conditioner for a vehicle according to the present embodiment can be roughly divided into two sections, that is, the air supply unit (air supply section) 1 and the air conditioning unit (air conditioning section) 2. The air supply unit 1 is arranged at a position offset from the center toward the passenger seat side at the lower part of the instrument panel in a vehicle compartment and, in contrast to this, the air conditioning unit 2 is arranged substantially at the center in the transverse direction of the vehicle at the lower part of the instrument panel.

On the upstream side of the air flow in an air conditioning case 3 forming an air flow channel, an inside air suction port 4 for sucking air in a vehicle compartment (inside air) and an outside air suction port 5 for sucking air outside the vehicle compartment (outside air) are formed and an inside/outside air switching door (inside/outside air switching means) 6 of a rotary door type for selectively opening and closing the suction ports 4 and 5 is provided.

On the downstream side of the inside/outside air switching door 6, a filter 7 for removing dust, etc. of the sucked air is inserted and on the further downstream side of the filter 7, a fan (air supply means) 8 comprising a multi-blade centrifugal (sirocco) fan 8a and a motor 8b is arranged and the air sucked through both the suction ports 4 and 5 by the fan 8 is supplied toward each of openings 14 and 15 to be described later.

On the downstream side of the air flow by the fan 8, an evaporator (cooling means) 9 constituting a heat exchanger for cooling air is arranged and the whole air supplied by the fan 8 passes through the evaporator 9. Further, on the downstream side of the air flow from the evaporator 9, a heater core (heating means) 10 constituting a heat exchanger for heating air is arranged and the heat core 10 heats air using cooling water (hot water) of an engine, not shown, as a heat source.

In the air conditioning case 3, a bypass passage 11 that bypasses the heater core 10 is formed and on the upstream side of the heater core 10, an air mix door (flow rate ratio adjusting means) 12 for adjusting the flow rate ratio between the air flow rate through the heat core 10 and the air flow rate through the bypass passage 11 is arranged. In the present embodiment, a film door of a roll-curtain type is used as the air mix door 12.

The outline of the air mix door 12 of a roll-curtain type is explained here. It is roughly divided into a cold air passage section 12A and a hot air passage section 12B, comprising a film f for opening and closing each of the passage sections, take-up rollers 121 and 122 for taking up or extending the film f, and roller slide mechanisms, not shown, for sliding the respective take-up rollers 121 and 122 substantially in the vertical (up-down) direction in FIG. 2.

Each of the take-up rollers 121 and 122 fixes one end of the film f to the outer circumferential surface thereof and has a gear at the end thereof, which engages with racks, not shown, provided on a frame portion W, and acts as a pinion. Each of the take-up rollers 121 and 122 can move in the vertical direction in the figure while rotating to take up or extend the film f.

A film fA, not shown, for the cold air passage section 12A fixes its other end to the lower side of the frame portion W, therefore, the roller 121 moves to the lowermost end while taking up the film fA in FIG. 2, which shows a state in which the cold air passage section 12A is fully open. Further, a film fB for the hot air passage section 12B fixes its other end to the lower side of the frame portion W, therefore, the roller 122 moves to the uppermost end while extending the film fB in FIG. 2, which schematically shows a state in which the hot air passage section 12B is completely closed.

Each of the roller slide mechanisms, not shown, has a screw cam with a spiral groove on its cylindrical outer circumferential surface and each end of the rollers 121 and 122 is engaged with the spiral groove and, by rotatably driving the screw cam by a stepping motor etc., each of the rollers 121 and 122 can be freely moved in its height direction (that is, the opening position) and held at an arbitrary height.

Then, by adjusting the opening ratio of both the passage sections 12A and 12B, the flow rate ratio of air flowing through both the passage sections 12A and 12B is adjusted and temperature adjustment of the conditioned air discharged into the vehicle compartment is made. Therefore, on the downstream side of the heater core 10, an air mix section 13, in which hot air having passed through the heater core 10 and cold air having passed through the bypass passage 11 meet with each other and are mixed with each other, is formed.

On the most downstream side of the air conditioning case 3, a face opening 14 from which conditioned air (mainly cold air) is discharged toward the upper body of a passenger in a vehicle compartment, a foot opening 15 from which conditioned air (mainly hot air) is discharged toward the feet of a passenger in a vehicle compartment, etc., are formed. Openings from which air is discharged further include a defroster opening from which conditioned air (mainly hot air) is discharged toward the inside of the windshield of a vehicle, a side face opening from which conditioned air is discharged toward the upper body of a passenger in a vehicle compartment from the right and left sides in a vehicle compartment, a side defroster opening from which conditioned air is discharged toward the inside of the side windows of a vehicle, etc., however, they are omitted in the present embodiment.

On the upstream side of the air flow through the above-mentioned openings 14 and 15, a face door 14a and a foot door 15a are arranged, respectively, and, by driving these doors with a drive means such as a servo motor, not shown, to open and close each of the openings, the discharge modes are switched. Then, to the front of each of the openings, an air distribution duct on the vehicle side, not shown, is connected. Specifically, to the face opening 14, a face duct for guiding air to a face discharge port facing the upper body of a passenger is connected, and to the foot opening 15, a foot duct for guiding air to a foot discharge port facing the feet of a passenger is connected, respectively.

As a characteristic structure, which is the premise of the present invention, the air conditioning unit 1 comprises, in addition to the normal bypass passage 11 through which the cold air cooled in the evaporator 9 flows toward the air mix section side while bypassing the heater core 10, a cold air bypass passage 16 designed such that the cold air cooled in the evaporator 9 flows efficiently to the face opening 14 while bypassing the heater core 10 and the air mix section 13 and the cold air bypass door (cold air bypass door means) for causing the air to flow intermittently by opening and closing the cold air bypass passage 16. Reference number 17 in FIG. 2 denotes a partition wall for separating the bypass passage 11 and the cold air bypass passage 16, integrally formed together with the air conditioning case 3.

Reference number 21 in FIG. 1 denotes an electronic control unit (ECU) for controlling drive means such as a servo motor, not shown, and the fan 8, and the control unit 21 is a well-known microcomputer comprising a central processing unit (CPU), a random-access memory (RAM), a read-only memory (ROM), etc.

To the control unit 21, a setting device, not shown, for setting a desired temperature in a vehicle compartment, an inside air temperature sensor for detecting the temperature in a vehicle compartment, an outside air temperature sensor for detecting the temperature of outside air, a solar radiation sensor for detecting the quantity of solar radiation entering a vehicle compartment, an evaporator outlet temperature sensor for detecting the temperature of the cold air from the evaporator 9, a water temperature sensor for detecting the temperature of engine cooling water, a potentiometer attached to the servo motor for detecting the position of the discharge mode, etc., are connected for data to be input.

Then, the control unit 21 outputs control signals to a motor controller, not shown, for driving the fan 8, a stepping motor, not shown, for driving the air mix door 12, servo motors, not shown, for driving the mode switching doors 14 and 15, etc., based on the input signals from the group of the sensors.

Next, the essential parts of the present invention are explained below. In the air conditioner for a vehicle shown in FIG. 1 and FIG. 2, the short circuit duct 18 for branching at least part of air flowing through the cold air bypass passage 16 and causing the fan 8 to suck it is provided. More specifically, the air introduction inlet 19 leading to the short circuit duct 18 is opened at the part of the air conditioning case 3 corresponding to the top surface of the cold air bypass passage 16 in FIG. 2 and the other end is opened as an air discharge port 20 on the upstream side of the fan 8 via the short circuit duct 18. The short circuit duct comprises the outer surface of the air conditioning case 3 and a cover part 18a installed from the further outer surface side of the air conditioning case 3.

Then, the air introduction inlet 19 on the air conditioning unit 2 side is opened and closed by the cold air bypass door 16a. In other words, when the cold air bypass door 16a closes the cold air bypass passage 16, the air introduction inlet 19 opens (refer to FIG. 2) and when the cold air bypass door 16a opens the cold air bypass passage 16, the air introduction inlet 19 closes (refer to FIG. 3).

Next, the operation of the air conditioner for a vehicle in the present embodiment is explained below. The normal operation is well known. Therefore, an explanation is omitted and the operation of the short circuit duct 18 and the cold air bypass door 16a that opens and closes it of the present invention is explained.

(1) At the initial stage of cool-down: the operation at the time of cool-down in order to bring the temperature in a vehicle compartment close to a set temperature after cooling starts is roughly divided into the initial mode for one to two minutes after cooling starts and the normal mode after that. First, in the initial mode for one to two minutes after cooling starts, the cold air bypass door 16a is operated so as to close the cold air bypass passage 16 to open the air introduction inlet 19 as shown in FIG. 2.

Then, most of air, which has passed through the evaporator 9 and flows through the cold air passage section 12A of the air mix door 12, flows from the bypass passage 11 through the air mix section 13 and is discharged from the face opening 14. On the other hand, the air having entered the cold air bypass passage 16 is guided toward the air introduction inlet 19 side by the cold air bypass door 16a, flows out from the air discharge port 20 after passing through the short circuit duct 18, and is mixed with the air sucked by the fan 8.

For one to two minutes after cooling starts, even if the evaporator 9 is cooled first, the air conditioner for a vehicle and the air distribution duct on the vehicle side are in a state in which heat is stored. If an attempt is made to increase the cooling heat quantity in a vehicle compartment in this state, a large quantity of warm air is discharged, causing a passenger to feel uncomfortable.

Then, by returning part of the air having passed through the evaporator 9 (the air having entered the cold air bypass passage 16 in the present embodiment) to the fan 8 for circulation, the temperature of the sucked air is reduced and as the air is cooled again in the evaporator 9, it is possible to quickly attain a lower discharge temperature. Due to this, the discharge flow rate is reduced, more or less, but it is possible to provide an excellent feeling of immediately effective coolness from the start of cooling even if there is a heat loss in the air distribution duct.

(2) At the normal stage of cool-down: FIG. 3 is a diagram showing a state in which the cold air bypass door 16a closes the air introduction inlet 19 leading to the short circuit duct 18 at B-B cross-section of the air conditioning unit 2 in FIG. 1. Then, when one to two minutes elapse after cooling starts, and not only the evaporator 9 but also the air conditioner for a vehicle and the air distribution duct is cooled enough and there is almost no heat loss, as a cool-down in the normal mode, the cold air bypass door 16a is operated so as to open the cold air bypass passage 16 to close the air introduction inlet 19, as shown in FIG. 3.

Due to this, the air having passed through the evaporator 9 flows through the cold air passage section 12A of the air mix door 12, then through the cold air bypass passage 16 and the bypass passage 11, and then through the air mix section 13, and is discharged from the face opening 14. From this point, a large flow rate of cold air is discharged to reduce the temperature in the vehicle compartment and cool-down is performed while providing a passenger with an excellent feeling of coolness.

(3) At the normal stage of temperature control: when cool-down is performed and the temperature in the vehicle compartment is brought close to the set temperature, the cold air bypass door 16a is operated so as to close the cold air bypass passage 16 in the normal temperature control mode. In this case, the air introduction inlet 19 is opened again and temperature control is performed as a result while performing air circulation using the short circuit duct 18.

Then, when the temperature in the vehicle compartment becomes almost the same as the set temperature, the air mix door 12 performs the temperature control by adjusting the openings of the cold air passage section 12A and the hot air passage section 12B to adjust the flow rate ratio of airs flowing through both the passage sections 12A and 12B.

(4) At the stage of high-load temperature control: finally, when a cooling load is high even in the temperature control mode because of strong solar radiation, etc., control is performed so that the cold air bypass passage 16, in addition to the normal bypass passage 11, is opened to increase the flow rate of cold air. At this time, as a matter of course, the cold air bypass door 16a is operated so as to open the cold air bypass passage 16.

Next, the features and effects of the present embodiment are described below. First, the short circuit duct 18, which branches at least part of the air flowing through the cold air bypass passage 16 so that the fan 8 can suck it, is provided.

Because of this devised structure, in which part of cold air is taken out at a position as close as possible after the evaporator 9 and is circulated again through a route as short as possible, the discharged air temperature is further reduced. Due to this, as for the problems that the temperature of sucked air is high and that the heat loss in the air distribution duct after the evaporator is large, it is possible to obtain the maximum effect that a sufficiently low discharged air temperature can be attained quickly by efficiently returning the cold air immediately after having passed through the evaporator 9 to the fan 8 through the shortest route, which can be realized by providing the air introduction inlet 19 directly to the air conditioning case 3 on the top surface of the already existing cold air bypass passage 16 immediately after the evaporator 9 and by using the dedicated short circuit duct 18 with small heat capacity from the air introduction inlet 19.

Further, the cold air bypass passage 16 has the cold air bypass door 16a for causing air to flow intermittently and the air introduction inlet 19 to the short circuit duct 18 is opened and closed by the cold air bypass door 16a. Due to this, it is possible to open and close the air introduction inlet 19 leading to the short circuit duct 18 using the already existing cold air bypass door 16a, therefore, the addition of a door means and a drive mechanism is not necessary and the cost can be reduced because only the addition of the short circuit duct 18 is required.

At least at the initial stage of cool-down when cooling starts, the air introduction inlet 19 is opened and air is caused to circulate using the short circuit duct 18. According to this, the discharge air flow rate is reduced, more or less. However, it is possible to quickly discharge cold air at a temperature low enough for a passenger to feel cool, therefore, an excellent feeling of immediately effective coolness can be given to the passenger.

Furthermore, at least a part of the short circuit duct 18 comprises the outer surface of the air conditioning case 3 and the cover part 18a installed from the further outer surface side. According to this, as it is possible to form the short circuit duct 18 by only attaching a simple cover part 18a to the outer surface of the air conditioning case 3, the cost can be reduced. On the other hand, there are advantages in reducing weight, saving a space, and raducing the quantity of heat accumulated in air distribution ducts.

### Other Embodiments

In the above-mentioned embodiment, the film door 12 of a roll-curtain type is used as the air mix door 12, however, the present invention is not limited to the above-mentioned embodiment and air may be mixed by general plate-type doors, etc. and the types of other doors are not limited.

Further, in the above-mentioned embodiment, the cold air bypass passage 16 is arranged on the downstream side of the air mix door 12, however, a cold air bypass passage may be provided at a position other than the variable range of the air mix door in which the air mix door can variably change the flow rate of air. Furthermore, the cold air bypass door 16a may be operated by a passenger independently of others based on his/her judgment and operation.

While the invention has been described by reference to specific embodiments chosen for the purposes of illustration, it should be apparent that numerous modifications could be made thereto, by those skilled in the art, without departing from the basic concept and scope of the invention.

1. An air conditioner for a vehicle comprising:
an air conditioning case for forming an air passage;
an air supply means arranged at one end of the air conditioning case and taking in air for air-conditioning to supply the air into the air conditioning case;
a cooling means for cooling air supplied from the air supply means;
a heating means for heating air having passed through the cooling means;
a bypass passage through which air having passed through the cooling means flows while bypassing the heating means;
an air flow rate ratio adjusting means arranged on an upstream side of the heating means and the bypass passage and adjusting air flow rate ratio between flow rate of air passing through the heating means and flow rate of air passing through the bypass passage;
an air mix section for mixing hot air heated by the heating means and cold air supplied from the bypass passage;
a face opening arranged at the other end of the air conditioning case and supplying air from the air mix section toward an upper body of a passenger in a vehicle compartment; and
a cold air bypass passage for guiding air having passed through the cooling means in the air conditioning case to the face opening while causing the air to bypass the heating means and the air mix section, wherein:
a short circuit duct for branching at least part of air flowing through the cold air bypass passage and causing the air supply means to suck it is provided;
an air introduction inlet for introducing air from the cold air bypass passage is provided on an outer surface of the air conditioning case; and
the short circuit duct is constituted of the outer surface of the air conditioning case and a cover part for covering the air introduction inlet from a further outer surface side with a space interposed between the cover part and the air introduction inlet and installed with a space interposed between the cover part and the outer surface of the air conditioning case.

2. The air conditioner for a vehicle as set forth in claim 1, wherein the cold air bypass passage has a cold air bypass door means for causing air to flow intermittently through the cold air bypass passage and the air introduction inlet leading to the short circuit duct is opened and closed by the cold air bypass door means.

3. The air conditioner for a vehicle as set forth in claim 2, wherein at least at an initial stage of cool-down when cooling starts, the air introduction inlet is opened and air is circulated using the short circuit duct.

4. The air conditioner for a vehicle as set forth in claim 1, wherein the air supply means is configured so as to take in air from a suction port provided on an upper side of the air supply means and supply it into the air conditioning case, the cold air bypass passage is provided on an upper side of the heating means, the air introduction inlet is provided on a top surface of the air conditioning case, the cover part is installed from an upper outer surface side of the air conditioning case, and an air discharge port through which air after having passed through the short circuit passage flows out to the air supply means is provided on an upper side of the air supply means and on a lower side of the suction port.

5. The air conditioner for a vehicle as set forth in claim 4, wherein a filter for removing dust in sucked air is provided between the air supply means and the suction port and the discharge port is provided on an upper side of the air supply means and on a lower side of the filter.
